(19) United States
(12) Patent Application Publication
(10) Pub. No.: US 2018/0037825 A1
(43) Pub. Date: Feb. 8, 2018

(54) FISCHER-TROPSCH PROCESS USING REDUCTIVELY-ACTIVATED COBALT CATALYST

(71) Applicants: Ewen FERGUSON, Yorkshire (GB); Manuel OJEDA PINEDA, Yorkshire (GB); Alexander PATERSON, Yorkshire (GB); Matthew James WELLS, Yorkshire (GB); BP P.L.C., London (GB)

(72) Inventors: Ewen FERGUSON, Saltend (GB); Manuel OJEDA PINEDA, Yorkshire (GB); Alexander PATERSON, Yorkshire (GB); Matthew James WELLS, Yorkshire (GB)

(73) Assignee: BP P.L.C.

(21) Appl. No.: 15/533,402

(22) PCT Filed: Dec. 2, 2015
(86) PCT No.: PCT/EP2015/078422

§ 371 Date: Jun. 6, 2017

(30) Foreign Application Priority Data
Dec. 12, 2014 (EP) 14197760.3

(51) Int. Cl. C10G 2/00; B01J 23/889; B01J 37/18; B01J 21/06

(52) U.S. Cl. CPC C10G 2/332; B01J 21/063; B01J 23/8892; B01J 37/18

(57) ABSTRACT

A process for the conversion of a feed comprising a mixture of hydrogen and carbon monoxide to hydrocarbons, the hydrogen and carbon monoxide in the feed being present in a ratio of from 1:9 to 9:1 by volume, the process comprising the steps of: pre-treating a catalyst composition comprising titanium dioxide support and oxidic cobalt or a cobalt compound decomposable thereto, for a period of from 1 to 50 hours, with a hydrogen gas-containing stream comprising less than 10% carbon monoxide gas by volume of carbon monoxide gas and hydrogen gas, to form a reductively-activated catalyst; and contacting the feed at elevated temperature and atmospheric or elevated pressure with the reductively-activated catalyst; wherein the step of pre-treating the catalyst composition is conducted within a temperature range of from 200° C. to less than 300° C., preferably from 220° C. to 280° C., more preferably from 250° C. to 270° C.

This invention relates to Fischer-Tropsch (FT) processes for the conversion of a feed comprising a mixture of carbon monoxide gas and hydrogen gas (e.g. synthesis gas (syngas)) to hydrocarbons over a cobalt catalyst comprising a titanium dioxide (titania) support, catalysts therefor and uses of/processes to produce said catalysts.

Known FT processes typically utilise a stable catalyst composition comprising oxidic cobalt, such as cobalt(II) dicobalt(III) oxide (also known as cobalt oxide or cobalt(II,III) oxide, i.e. Co₃O₄) which may be supported on titanium dioxide, and employ a reduction step in order to activate the catalyst by reducing the cobalt(II,III) oxide to elemental (or metallic) cobalt (Co⁰) which is understood to be the catalytically active species. It has thus been thought desirable to reduce as much of the cobalt present as possible in order to improve the activity of the resultant catalyst, requiring harsh conditions, such as high temperature. See Batholomew et al, Journal of Catalysis 128, 231-247 (1991). U.S. Pat. No. 7,851,404 discloses an FT process utilising a reduced cobalt catalyst comprising a titanium dioxide support and a hydrogen reduction step, exemplifying a reduction temperature of 425° C. However, there remains an ongoing need to improve FT processes, including improving or maintaining the properties of FT catalysts, most notably in relation to their activity, i.e. enabling greater conversion of syngas to hydrocarbons for the same temperature (or equal conversion at lower temperatures) and enabling more desirable selectivity, such as selectivity towards producing hydrocarbons having at least 5 carbon atoms (C₅₊), or selectivity away from producing methane, especially when operating the overall process with less energy intensive conditions (e.g. lower temperature). Surprisingly, it has now been found that, provided a hydrogen gas reduction step is used, milder reduction conditions (e.g. lower temperature) may be utilised while still achieving at least acceptable, and even enhanced, catalyst activity and C₅₊ selectivity in an FT process.

According to a first aspect, the present invention thus relates to a process for the conversion of a feed comprising a mixture of hydrogen and carbon monoxide to hydrocarbons, the hydrogen and carbon monoxide in the feed being present in a ratio of from 1:9 to 9:1 by volume, the process comprising the steps of: pre-treating a catalyst composition comprising titanium dioxide support and oxidic cobalt or a cobalt compound decomposable thereto, for a period of from 1 to 50 hours, with a hydrogen gas-containing stream comprising less than 10% carbon monoxide gas by volume of carbon monoxide gas and hydrogen gas, to form a reductively-activated catalyst; and contacting the feed at elevated temperature and atmospheric or elevated pressure with the reductively-activated catalyst; wherein the step of pre-treating the catalyst composition is conducted within a temperature range of from 200° C. to less than 300° C., preferably from 220° C. to 280° C., more preferably from 250° C. to 270° C.

As used herein, the general term “cobalt” includes cobalt either in metallic (elemental) form or as part of a cobalt compound (i.e. referring to the total cobalt present), so for example where the catalyst is referred to as “comprising cobalt”, it is intended to mean that the catalyst comprises metallic/elemental cobalt and/or at least one cobalt compound. Commensurately, the mass of cobalt includes the total mass of cobalt atoms and ions present, i.e. ignoring any other ions in any cobalt compounds. As used herein, the more specific terms “metallic cobalt” or “elemental cobalt” mean cobalt in an oxidation state of zero, i.e. Co⁰. It is also recognised that exposing the catalyst to the feed itself at elevated temperature may further reductively-activate the catalyst. However, even if further reduction of the catalyst occurs upon, or following exposure to the feed, it has been found that the benefits of the present invention remain, and accordingly this is specifically included within the scope of the present invention.

The catalyst employed in the present invention may be obtained by pre-treating a catalyst composition comprising titanium dioxide support and oxidic cobalt or a cobalt compound decomposable thereto, with a reducing agent. Accordingly, a pre-treatment, or reduction step, may be used to obtain the degree of reduction, i.e. by reducing the catalyst.

Suitably, a pre-treatment step which may be a gaseous reduction, i.e. using a reducing gas stream, may be employed. If a reducing gas stream is used, it advantageously comprises at least 25 vol. % of a reducing gas, preferably at least 50 vol. % of a reducing gas, more preferably at least 75 vol. % reducing gas, even more preferably at least 90 vol. % reducing gas, even more preferably still at least 95 vol. % reducing gas and yet further preferably is substantially entirely made up of reducing gas. Any remainder may comprise, or be, inert diluents such as argon, helium, nitrogen and/or water vapour, or minor components such as hydrocarbons (e.g. methane) or carbon dioxide. The reducing gas referred to in the present invention is molecular hydrogen (H₂), also known as hydrogen gas.

As hydrogen gas is being utilised, it is suitable that the reducing gas stream comprises less than 10% carbon monoxide gas (by volume of hydrogen gas and carbon monoxide gas) in order to prevent premature reaction start-up and a resultant poorly performing catalyst. For the avoidance of any doubt, the upper limit of carbon monoxide which may be present in the reducing gas as reported herein is relative only to the volume of molecular hydrogen in the gaseous stream, and not relative to the combined volume of hydrogen and any inert diluents or other components.

Suitably, the pre-treating step may be performed at any desired pressure, for instance a pressure (e.g. feed pressure) from 10 to 5500 kPa, preferably from 20 to 3000 kPa, more preferably from 50 to 1000 kPa, and even more preferably from 100 to 800 kPa. During this step, reducing gas (i.e. comprisng or being hydrogen gas) is suitably passed over the catalyst bed at a gas hourly space velocity (GHSV) in the range from 100 to 10000 h⁻¹, preferably from 250 to 5000 h⁻¹, such as from 250 to 3000 h⁻¹ and more preferably from 250 to 2000 h⁻¹, for example 1000 h⁻¹. As used herein, unless otherwise specified, GHSV means gas hourly space velocity on gas volumes converted to standard temperature and pressure based on the catalyst bed volume.

The pre-treating step of reducing a catalyst advantageously occurs at a temperature of from 200° C. to less than 300° C. or from 220° C. to less than 300° C., preferably from 220° C. to 280° C. or from 220° C. to 250° C., more preferably from 230° C. to 250° C., such as 240° C. Alternatively, the pre-treating step of reducing a catalyst advantageously may occur at a temperature of from 250° C. to less than 300° C., from 250° C. to 280° C. or from 250° C. to 270° C., such as 260° C. These temperature ranges particularly apply (non-exclusively) when the catalyst composition and/or reductively-activated catalyst comprises certain levels of promoter as will be discussed later. As used herein, temperatures may refer to feed temperatures, applied temperatures and/or catalyst bed temperatures and may particularly be catalyst bed temperatures.

The precise duration of the pre-treatment step is also important to the present invention. Exemplary durations of the pre-treatment step, which may be in combination with any of the temperature ranges specified above, include from 1 to 50 hours, preferably from 5 to 35 hours, more preferably from 7 to 20 hours, and even more preferably from 10 to 15 hours.

For convenience, the pre-treatment step may desirably occur in the same reactor used for the subsequent conversion of syngas to hydrocarbons (“in situ”) in order to reduce the time and effort required loading and unloading catalysts. Reducing in situ also mitigates the need for any steps to ensure the degree of reduction achieved during the pre-treatment step remains present when the conversion of syngas to hydrocarbons is commenced. The pre-treatment step may, however, also be carried out in another location apart from the FT reactor (“ex situ”).

The complete reduction of cobalt oxide (Co₃O₄) is a two-step process (firstly the reduction to cobalt(II) oxide, also known as cobaltous oxide, and then the reduction of cobalt(II) oxide to metallic cobalt) as shown by the chemical equations below:

Co₃O₄+H₂→3CoO+H₂O

COO+H₂→Co⁰+H₂O

Equations 1 and 2: Step-wise reduction of cobalt(II,III) oxide to metallic cobalt

The overall reduction may alternatively be represented as a single stoichiometric equation:

Co₃O₄+4H₂→3CoO+H₂O+3H₂→3Co⁰+4H₂O

Equation 3: Overall reduction of cobalt(II,III) oxide to metallic cobalt

To prevent the pre-treated catalyst being found to be more poorly performing following any period in storage, transport or other intermediate steps that may occur before the catalyst is used to produce hydrocarbons, (e.g. via re-oxidation), additional measures may be taken, for example avoiding exposure of the catalyst to an oxidising atmosphere during storage and transport. Such avoidance of oxidising atmospheres may be achieved by packing the catalyst in an inert (e.g. nitrogen) atmosphere, packing the catalyst in a reducing atmosphere (e.g. 5% H₂, 95% nitrogen by volume), passivating by creating a thin, protective oxide layer on the surface of the catalyst, or wax-coating the catalyst. These measures may especially be taken prior to any storage and/or transport.

The catalyst used in accordance with the present invention may comprise a cobalt compound intended to be reduced to metallic cobalt. The identity of the cobalt compound is not particularly limited except that the cobalt compound should be decomposable (either directly or indirectly (e.g. via intermediates) to metallic cobalt, including mixtures of such compounds. Preferably, the cobalt compound is oxidic cobalt, a cobalt compound decomposable thereto or mixtures thereof, for example cobalt(III) oxide, cobalt(II,III) oxide, and/or cobalt(II) oxide, compounds decomposable to cobalt(III) oxide, cobalt(II,III) oxide, and/or cobalt(II) oxide, and mixtures thereof. More preferably, the cobalt compound is cobalt(II,III) oxide, cobalt(II) oxide, a cobalt compound that is decomposable to cobalt(II,III) oxide and/or cobalt(II) oxide, or mixtures thereof, for example cobalt(II,III) oxide, cobalt(II) oxide, cobalt nitrate (e.g. cobalt nitrate hexahydrate), cobalt acetate or cobalt hydroxide. Even more preferably, the cobalt compound is cobalt(II,III) oxide, cobalt(II) oxide or mixtures thereof, as this removes the need for additional calcination/oxidation/decomposition steps to prepare the oxide, and even more preferably still the cobalt compound is cobalt(II,III) oxide. If a cobalt compound other than oxidic cobalt is used, this may be referred to herein as a catalyst precursor, from which the calcination/oxidation/decomposition step used to form cobalt oxide may be carried out in situ or ex situ with respect to the hydrocarbon synthesis reactor or with respect to the reduction step.

The amount of cobalt compound present in the catalyst is not particularly limited. According to some embodiments of the present invention, the catalyst comprises from 5% to 30%, preferably from 5% to 25% and more preferably from 10% to 20%, cobalt compound by weight of the catalyst.

The catalyst also comprises titanium dioxide (also referred to herein as titania) as a supporting material for the cobalt compound. The catalyst may further comprise one or more promoters in order to improve the activity of the catalyst. Non-limiting examples of promoters include: chromium, nickel, iron, molybdenum, tungsten, manganese, boron, zirconium, gallium, thorium, lanthanum, cerium, ruthenium, rhodium, rhenium, palladium, platinum and/or mixtures thereof. The one or more promoters may be present as the elemental metal or as a compound, for example an oxide. In some embodiments, the promoter comprises, or is selected from platinum, molybdenum or mixtures thereof, for example molybdenum. Such promoters may be present in an amount up to 15% by weight of the catalyst but may be advantageously present in an amount of from 0% to 5% by weight of the catalyst, from 0.1% to 3% by weight of the catalyst, or from 0.5% to 2.5% by weight of the catalyst. Particular examples (for example manganese) may be from 1% to 2.5% or from 1.5% to 2.25%, for example 2%. As mentioned earlier, each promoter weight range above may particularly apply in combination with temperature ranges of the pre-treatment step such as from 220° C. to 280° C., preferably from 220° C. to 250° C. and more preferably from 230° C. to 250° C., such as 240° C. in order to further improve catalyst performance in respect of activity and C₅₊ selectivity. Alternative amounts of promoter (e.g. manganese) that may be used include from 0.1% to 1.5%, from 0.5% to 1.5%, from 0.75% to 1.25% or from 0.8% to 1.2%, such as 1%, especially in combination with temperature ranges of the pre-treatment step such as from 250° C. to less than 300° C., preferably from 250° C. to 280° C. and more preferably from 250° C. to 270° C., such as 260° C., in order to obtain an enhanced balance overall catalyst performance while being able to use milder pre-treatment conditions.

The catalyst may be prepared by any known method, including impregnation, precipitation or gelation. A suitable method, for example, comprises impregnating titanium dioxide with a compound of cobalt that is thermally decomposable to metallic cobalt (e.g. via the oxide), such as cobalt nitrate, cobalt acetate or cobalt hydroxide. Any suitable impregnation technique including the incipient wetness technique or the excess solution technique, both of which are well-known in the art, may be employed. The incipient wetness technique is so-called because it requires that the volume of impregnating solution be predetermined so as to provide the minimum volume of solution necessary to just wet the entire surface of the support, with no excess liquid. The excess solution technique as the name implies, requires an excess of the impregnating solution, the solvent being thereafter removed, usually by evaporation. The impregnation solution may suitably be either an aqueous solution or a nonaqueous, organic solution of the cobalt compound. Suitable nonaqueous organic solvents include, for example, alcohols, ketones, liquid paraffinic hydrocarbons and ethers. Alternatively, aqueous organic solutions, for example an aqueous alcoholic solution, of the thermally decomposable cobalt compound may be employed.

Following preparation, the catalyst may also be formed by any known technique including extrusion, pulverisation, powderisation, pelletisation, granulation and/or coagulation. Preferably, the catalyst is extruded, for example to enable less pressure drop in a reactor and highly consistent diameter of the catalyst. In extrusion, an extrudable paste may be formed, such as from a mixture of the catalyst components in water, which is then extruded into the desired shape and dried to form the catalyst. Alternatively, an extrudable paste of titanium dioxide may be formed from a mixture of powdered titanium dioxide and water. This paste may then be extruded and typically dried and/or calcined to form the desired shape, which may then be contacted with a solution of a cobalt compound in order to impregnate the extruded support material with the cobalt compound. The resultant impregnated support material may then be dried to form the catalyst, which if not already comprising oxidic cobalt such as cobalt(III) oxide, cobalt(II,III) oxide or cobalt(II) oxide may also be calcined.

As indicated above, the present invention provides, in a first aspect, a process for the conversion of a feed comprising a mixture of hydrogen and carbon monoxide, preferably in the form of a synthesis gas mixture, to hydrocarbons, which process comprises contacting the feed with a reductively activated catalyst composition as hereinbefore described.

In the hydrocarbon synthesis processes described herein, the volume ratio of hydrogen to carbon monoxide (H₂:CO) in the feed is in the range of from 1:9 to 9:1 preferably in the range of from 0.5:1 to 5:1, more preferably from 1:1 to 3:1, and most preferably from 1.6:1 to 2.2:1. Such ratios especially apply as regards the feed to the reactor, e.g. at the reactor inlet. The feed may also comprise other gaseous components, such as nitrogen, carbon dioxide, water, methane and other saturated and/or unsaturated light hydrocarbons, each preferably being present at a concentration of less than 30% by volume. The temperature of the reaction (or reactor) is elevated, preferably in the range from 100 to 400° C., more preferably from 150 to 350° C., and most preferably from 150 to 250° C. The pressure of the reaction (or reactor) is atmospheric or elevated, preferably in the range from 1 to 100 bar (from 0.1 to 10 MPa), more preferably from 5 to 75 bar (from 0.5 to 7.5 MPa), and most preferably from 10 to 50 bar (from 1.0 to 5.0 MPa). As used herein “elevated” in relation to conditions refers to conditions greater than standard conditions, for example, temperatures and pressures greater than standard temperature and pressure (STP).

The gaseous reactants (feed) for the present process may be fed into the reactor either separately or pre-mixed (e.g. as in the case of syngas). They may initially all contact the solid catalyst at the same portion of the solid catalyst, or they may be added at different positions of the solid catalyst. The ratio of hydrogen gas to carbon monoxide gas may thus be determined from the relative flow rates when both streams are flowing. Preferably, the one or more gaseous reactants flow co-currently over the solid catalyst.

The feed used for the present process may also comprise recycled materials extracted from elsewhere in the process, such as unreacted reactants separated from any reduction steps associated with the process of the invention.

The mixture of hydrogen and carbon monoxide is suitably passed over the catalyst bed at a gas hourly space velocity (GHSV) in the range from 100 to 10000 h⁻¹ (gas volumes converted to standard temperature and pressure), preferably from 250 to 5000 If % such as from 250 to 3000 h⁻¹, and more preferably from 250 to 2000 h⁻¹.

As is well known in the art, synthesis gas, which is preferably used as the feed for the present process, principally comprises carbon monoxide and hydrogen and possibly also minor amounts of carbon dioxide, nitrogen and other inert gases depending upon its origin and degree of purity. Methods of preparing synthesis gas are established in the art and usually involve the partial oxidation of a carbonaceous substance, e.g. coal. Alternatively, synthesis gas may be prepared, for example by the catalytic steam reforming of methane. The ratio of carbon monoxide to hydrogen present in the synthesis gas may be altered appropriately by the addition of either carbon monoxide or hydrogen, or may be adjusted by the so-called shift reaction well known to those skilled in the art.

The process of the invention may be carried out batch wise or continuously in a fixed bed, fluidised bed or slurry phase reactor. When using the catalyst as described in the present invention in a fixed bed process, the particle size should be of such shape and dimension that an acceptable pressure drop over the catalyst bed is achieved. A person skilled in the art is able to determine the particle dimension optimal for use in such fixed bed reactors. Particles of the desired shape and dimension may be obtained by extrusion of a paste to which optionally extrusion aids and/or binders may be optionally added.

In a second aspect, the present invention also provides a product (preferably a fuel) comprising hydrocarbons obtained from a process according to the first aspect. As the product results from a process for the conversion of a feed comprising a mixture of hydrogen gas and carbon monoxide gas to hydrocarbons (to which the first aspect of the invention relates), any features of the process described above in relation to the first aspect are applicable to this second aspect, either individually or in any combination.

According to third, fourth and fifth aspects, the present invention relates to a process for making a Fischer-Tropsch catalyst comprising the step of: treating a catalyst composition comprising titanium dioxide support, and oxidic cobalt or a cobalt compound decomposable thereto, for a period of from 1 to 50 hours, with a hydrogen gas-containing stream comprising less than 10% carbon monoxide gas by volume of carbon monoxide gas and hydrogen gas, to form the Fischer-Tropsch catalyst, wherein the step of treating the catalyst composition is conducted within a temperature range of from 200° C. to less than 300° C., preferably from 220° C. to 280° C., more preferably from 250° C. to 270° C., the catalysts so produced, and the use of said catalysts in a process for the conversion of a feed comprising a mixture of hydrogen gas and carbon monoxide gas to hydrocarbons. As these aspects each relate to a process for the conversion of a feed comprising a mixture of hydrogen gas and carbon monoxide gas to hydrocarbons (to which the first aspect of the invention relates), any features of the process described above in relation to the first aspect are applicable to these third, fourth and/or fifth aspects, either individually or in any combination.

### EXAMPLES

### Examples 1-4

Cobalt oxide supported on titanium dioxide was manufactured as a catalyst by impregnating titanium dioxide powder with an aqueous solution of cobalt nitrate hexahydrate, followed by extrusion of the formed paste, and then drying and calcining to yield catalyst extrudates with a cobalt loading of 10% by weight of catalyst and a manganese loading of 1% by weight of catalyst. The catalyst sample was thus cobalt oxide on titanium dioxide support, 10 wt. % cobalt loading, 1 wt. % manganese loading. 9.6 g of catalyst sample was loaded into a metal liner of a multi-channel catalyst-screening microreactor. Each channel of the microreactor underwent the same drying procedure in parallel, before the catalysts were activated according to the following protocols under 100% H₂ gas at a GHSV of 3800 h⁻¹ and pressure of 1 atm: Example 1 (inventive): From room temperature ramped to 150° C. at a rate of 2° C./min, then ramped to 200° C. at a rate of 1° C./min, before dwelling at 200° C. for 15 hours.

### Example 2 (Inventive)

From room temperature ramped to 150° C. at a rate of 2° C./min, then ramped to 240° C. at a rate of 1° C./min, before dwelling at 240° C. for 15 hours.

### Example 3 (Inventive)

From room temperature ramped to 150° C. at a rate of 2° C./min, then ramped to 260° C. at a rate of 1° C./min, before dwelling at 260° C. for 15 hours.

### Example 4 (Comparative)

From room temperature ramped to 150° C. at a rate of 2° C./min, then ramped to 300° C. at a rate of 1° C./min, before dwelling at 300° C. for 15 hours.

The liners were then cooled, purged with nitrogen, and temperature ramped identically under a 1.8:1 H₂:CO molar stream of syngas in 18% N₂ at 30 barg total pressure at a GHSV of 1250 h⁻¹. Each example was operated at a temperature of 201-214° C. in order to achieve the same level of conversion, under identical operating conditions with results presented in Table 1. The data for the inventive example shows acceptable selectivity to C₅₊ and CH₄ alongside a similar temperature to reach the same CO conversion rate versus comparative example 4, despite the milder reduction conditions. Example 3 also shows improved selectivity to C₅₊ and CH₄ alongside a lower temperature to reach the same CO conversion rate versus example 2. Furthermore, Example 3 actually demonstrates a relatively small loss of C5+ selectivity versus example 4 despite a 40° C. drop in activation temperature, while a much more significant loss of C5+ selectivity is seen between example 3 and example 2 with only a 20° C. drop in activation temperature. This steeper loss of C5+ selectivity is then maintained to example 1.

TABLE 1
Performance data of examples 1-4 in
conversion of syngas to hydrocarbons

| | Example | | | |
|---|---|---|---|---|
| | 1 | 2 | 3 | 4 |
| Pre-reduction Temperature (° C.) | 200 | 240 | 260 | 300 |
| GHSV (h⁻¹) | 1250 | 1250 | 1250 | 1250 |
| Temperature (° C.) | 214 | 201 | 200 | 198 |
| CO Conversion (%) | 67 | 65 | 65 | 65 |
| C₅₊ Selectivity (%) | 74.8 | 81.8 | 85.0 | 86.8 |
| CH₄ Selectivity (%) | 15.0 | 10.8 | 8.9 | 7.4 |

### Examples 5-7

The catalyst sample was cobalt oxide on titanium dioxide support, 10 wt. % cobalt loading, 2 wt. % manganese loading. Each catalyst sample (mass provided in Table 2) was loaded into a metal liner of a multi-channel catalyst-screening microreactor. Each channel of the microreactor underwent the same drying procedure in parallel, before the catalysts were activated according to the following protocols under 100% H₂ gas at a GHSV 3800 h⁻¹ and pressure of 1 atm:

From room temperature, ramped to 150° C. at a rate of 2° C./min, then ramped to 240° C. (example 5), 260° C. (example 6) or 300° C. (example 7, comparative) at a rate of 1° C./min, before dwelling at this final temperature for 15 hours.

The liners were then cooled, purged with nitrogen, and temperature ramped identically under a 1.8:1 H₂:CO molar stream of syngas in 18% N₂ at 30 barg total pressure and a GHSV of 1250 h⁻¹. Each example was operated at a temperature of 195° C. under identical operating conditions with results presented in Table 3. The data for example 5 clearly shows improved selectivity to C₅₊ and similar selectivity to CH₄ alongside similar temperatures to reach the same CO conversion rate versus example 7, despite the milder reduction conditions leading to a lower degree of reduction, and even despite a lower mass of catalyst having been used, indicating improved activity. Similarly, example 6 provides comparable performance to example 7 despite less catalyst having been used.

TABLE 2
Performance data of examples 5-7 in
conversion of syngas to hydrocarbons

| | Example | | |
|---|---|---|---|
| | 5 | 6 | 7 |
| Mass of Catalyst (g) | 8.6 | 8.8 | 9.4 |
| Pre-reduction Temperature (° C.) | 240 | 260 | 300 |
| GHSV (h⁻¹) | 1250 | 1250 | 1250 |
| Temperature (° C.) | 204 | 206 | 203 |
| CO Conversion (%) | 64 | 64 | 63 |
| C₅₊ Selectivity (%) | 83.7 | 81.0 | 82.5 |
| CH₄ Selectivity (%) | 9.3 | 10.1 | 9.2 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope and spirit of this invention.

1-16. (canceled)

17. A process for the conversion of a feed comprising a mixture of hydrogen and carbon monoxide to hydrocarbons, the hydrogen and carbon monoxide in the feed being present in a ratio of from 1:9 to 9:1 by volume, the process comprising the steps of:
a. pre-treating a catalyst composition comprising:
i. titanium dioxide support, and
ii. oxidic cobalt or a cobalt compound decomposable thereto,
for a period of from 1 to 50 hours, with a hydrogen gas-containing stream comprising less than 10% carbon monoxide gas by volume of carbon monoxide gas and hydrogen gas, to form a reductively-activated catalyst; and
b. contacting the feed at elevated temperature and atmospheric or elevated pressure with the reductively-activated catalyst;
wherein the step of pre-treating the catalyst composition is conducted within a temperature range of from 200° C. to less than 300° C., preferably from 220° C. to 280° C., more preferably from 250° C. to 270° C.

18. A process according to claim 17, wherein step a occurs for a period of from 5 to 35 hours, preferably from 7 to 20 hours, and even more preferably from 10 to 15 hours.

19. A process according claim 17, wherein the gas hourly space velocity (GHSV) of the hydrogen gas-containing stream in step a is in the range of from 100 to 10000 h-¹, preferably from 250 to 5000 h-¹, such as from 250 to 3000 h-′ and more preferably from 250 to 2000 h-¹.

20. A process according to claim 17, wherein the step of pre-treating the catalyst composition is conducted within a temperature range of from 250° C. to less than 300° C., preferably from 250° C. to 280° C., more preferably from 250° C. to 270° C.

21. A process according to claim 17, wherein step a is carried out at a feed pressure of from 10 to 5500 kPa, preferably from 20 to 3000 kPa, more preferably from 50 to 1000 kPa, and even more preferably from 100 to 800 kPa.

22. A process according to claim 17, wherein the mixture of hydrogen and carbon monoxide is in the form of synthesis gas, preferably wherein the synthesis gas comprises hydrogen gas and carbon monoxide gas at a ratio in the range of from 0.5:1 to 5:1 by volume, preferably in the range of from 1:1 to 3:1 by volume, more preferably in the range of from 1.6 to 2.2:1 by volume.

23. A process according to claim 17, wherein the catalyst composition and/or the reductively-activated catalyst comprises from 5% to 30%, preferably from 5% to 25% and more preferably from 10% to 20%, cobalt by weight of the catalyst.

24. A process according to claim 17, wherein the catalyst composition and/or the reductively-activated catalyst further comprises one or more promoters selected from chromium, nickel, iron, molybdenum, tungsten, manganese, boron, zirconium, gallium, thorium, lanthanum, cerium, ruthenium, rhenium, palladium, platinum, compounds and/or mixtures thereof.

25. A process according to claim 24, wherein the promoter is present in an amount of from 0% to 5%, preferably from 0.1% to 3%, and more preferably 0.5% to 2.5%, by weight of the catalyst.

26. A process according to claim 24, wherein the promoter is manganese and is present in an amount of from 0.5% to 2.5%, preferably from 1% to 2.5% and more preferably from 1.5% to 2.25%.

27. A process according to claim 24, wherein the promoter is manganese and is present in an amount of from from 0.1% to 1.5%, preferably from 0.5% to 1.5%, more preferably from 0.75% to 1.25% and even more preferably from 0.8% to 1.2%.

28. A process according to claim 17, wherein the oxidic cobalt or a cobalt compound decomposable thereto is selected from cobalt(III) oxide, cobalt(II,III) oxide, cobalt(II) oxide, compounds decomposable thereto, or mixtures thereof.

29. A product, preferably a fuel, comprising hydrocarbons obtained by a process according to claim 17.

30. A process for making a Fischer-Tropsch catalyst comprising the step of:
c. treating a catalyst composition comprising:
i. titanium dioxide support, and
ii. oxidic cobalt or a cobalt compound decomposable thereto,
for a period of from 1 to 50 hours, with a hydrogen gas-containing stream comprising less than 10% carbon monoxide gas by volume of carbon monoxide gas and hydrogen gas, to form the Fischer-Tropsch catalyst, wherein the step of pre-treating the catalyst composition is conducted within a temperature range of from 200° C. to less than 300° C., preferably from 220° C. to 280° C., more preferably from 250° C. to 270° C.

31. A Fischer-Tropsch catalyst produced by the process of claim 30.
